(19) United States
(12) Patent Application Publication
(10) Pub. No.: US 2012/0054837 A1
(43) Pub. Date: Mar. 1, 2012

(54) NETWORK CONTROL METHOD FOR CONTROLLING CLIENT-AND-SERVER BASED HIGH RELIABILITY SESSION FOR SECURE PAYMENT USING MULTI INTERFACE USER TERMINAL IN WIRED OF WIRELESS INTERNET

(75) Inventors: Sunghyun Yoon, Daejeon (KR); Ho Sun Yoon, Daejeon (KR); Seong Moon, Daejeon (KR); Jong Dae Park, Daejeon (KR); Young Boo Kim, Daejeon (KR); Soon Seok Lee, Daejeon (KR)

(73) Assignee: Electronics and Telecommunications Research Institute, Daejeon (KR)

(21) Appl. No.: 13/168,277

(22) Filed: Jun. 24, 2011

(30) Foreign Application Priority Data
Sep. 1, 2010 (KR) 10-2010-0085529

(51) Int. Cl. G06F 17/30

(52) U.S. Cl. 726/4

(57) ABSTRACT

A network control method for controlling a client-and-server based high-reliability session for secure payment using a multi interface user terminal in the wired or wireless Internet is provided. The network control method establishes an active and standby secure channel between a client equipped to a terminal including a plurality of network interfaces and a server to control each terminal based on a terminal identifier (ID). The method continuously receives terminal state information through the secure channel, and identifies a homogeneous or heterogeneous access network and the secure channel to which a user terminal connects based on the terminal state information, thereby securely authenticating the user terminal requesting payment to a payment gateway (PG) system. Accordingly, the PG system may securely authenticate the user terminal and perform the payment.

### CROSS-REFERENCE TO RELATED APPLICATION

This application claims the benefit of Korean Patent Application No. 10-2010-0085529, filed on Sep. 1, 2010, in the Korean Intellectual Property Office, the disclosure of which is incorporated herein by reference.

### BACKGROUND

1. Field of the Invention

The present invention relates to a method for securely providing real time Internet service which is sensitive to the matter of personal data in a heterogeneous mobile environment.

2. Description of the Related Art

According to generalization of information communication services and development of the Internet technology, services sensitive to data security, for example financial services such as online stock trading, electronic commerce, and Internet banking, are being widely performed through the Internet. As a result, not only protection of personal data but also overall service safety including user authentication using the personal data are becoming more important.

In addition, as smart phones functioning as small computers are gaining popularity as of late, wireless Internet services is increasing. Accordingly, necessity for a secure payment system is greatly increasing in wireless networks which are more vulnerable to security attacks than wired networks.

At present, a user authentication method for use of the Internet services is generally based on personal data such as information of subscribers of the corresponding services. However, such a method of using the personal data is very poorly prepared to deal with leakage of the personal data.

Specifically, for the Internet payment, various types of the personal data are used, such as an identifier (ID) and password, a mobile one time password (OTP), an electronic certification, and the like. These types of personal data are subject to leakage by various attacks.

For example, the attacks include personal data hacking. In a case of a computer, the leakage may occur due to infection by a virus such as a Trojan horse. In case of smart phones, the leakage may occur due to infection by malicious mobile codes such as a malicious application. In response, security programs including anti-virus programs and firewalls have been developed to overcome the attacks. However, functions of such security programs are limited to removal of already known malicious programs. That is, when a certain virus is newly produced and spread, the virus would be detected after infecting lots of terminals, and production of an anti-virus program to remove the virus will follow. Thus, an increase of a terminal security level may not completely remove the risk of personal data being leaked.

Moreover, in the wireless environment as in smart phones, differently from the general wired environment like desktop computers, most functions for use of the services are obtained by downloading from the Internet and installing application programs at a convenience of a user. Thus, if an application program containing a malicious code is executed, personal data of the user may be leaked.

Furthermore, leakage of personal data is more serious in an offline state rather than an online state because of illegal trading of personal data collected by insider data leakage or other methods, abuse of personal data by a person legally qualified for referring to personal data of others, terminal cloning by terminal sellers or agents, and the like. More seriously, even an increase of security level of a terminal device cannot solve such offline leakage of personal data since the offline leakage is performed irrespective of the terminal device.

Therefore, various additional methods have been used to improve the weak security regarding the personal data leakage. For example, credentials of a user may be double checked using a dedicated bypass such as a mobile network. However, this method is also subject to theft by attackers through terminal duplication or malicious program infection.

As of now, phone banking, also called tele-banking or automatic response system (ARS) banking, is a relatively secure payment method. Phone banking is achieved through the wired phone network which uses network line information in addition to personal data. Since phone banking permits payment only on a designated line, a risk of the personal data leakage is relatively low. That is, the phone banking system is actually secure because, although the personal data is leaked, payment is not performed on the other lines but the designated line. However, due to the limit to the designated line, the phone banking does not provide mobility to users.

To reduce the limits of the phone banking, the mobile communication network provides a ‘mobile banking’ service which uses terminal information, such as an intrinsic number of a mobile terminal, in addition to the personal data used in the wired phone banking. The mobile banking is relatively secure since the payment is approved using a combination of terminal information registered with a user and the personal data, that is, the payment is approved only in the terminal of the user but not in the other terminals. Also, the mobile banking enables payment during travelling, due to characteristics of the mobile communication network. That is, differently from the phone banking, the limit of connection area may be overcome.

However, conventional mobile banking is inapplicable in a heterogeneous mobile environment being recently popularized according to expansion of wireless Internet. A secure channel provided by the mobile banking is secure in a single frequency mobile communication network. However, for handover between heterogeneous networks, the secure channel of the mobile banking cannot provide continuity due to session change.

Furthermore, with the popularization of smart phones basically equipped with 2W and 3W, such as wireless fidelity (WiFi), wireless broadband (WIBRO), and wide-band code division wireless multiple access (WCDMA), wireless Internet traffic is greatly increasing. Therefore, communications providers are converting WCDMA traffic to the WiFi or WIBRO network having a relatively greater bandwidth. Afterward, handover between heterogeneous networks in the wireless Internet environment will gradually increase.

Accordingly, there is a demand for a new technology providing continuity of real time security in the heterogeneous mobile environment.

### SUMMARY

An aspect of the present invention provides an Internet security control technology guaranteeing secure payment and user authentication unless a terminal is lost although personal data is leaked, in using the Internet services such as electronic commerce.

According to an aspect of the present invention, there is provided an Internet security control technology includes a client function equipped to a mobile terminal including a plurality of network interfaces to manage Internet reachability of the mobile terminal, and a server function to provide reliability among terminals by achieving a security relationship with a client, based on a unique identifier (ID) of the client, and tracing and managing the state of the mobile terminal.

### EFFECT

According to embodiments of the present invention, there is provided a secure payment and authentication service guaranteeing highly reliable security regarding leakage and theft of personal data, by authenticating not only personal data of a user but also a user terminal necessary for use of the Internet service.

Additionally, according to embodiments of the present invention, a secure payment service is provided, which guarantees continuity of a secure channel even in the Internet environment where handover between heterogeneous networks is frequent.

Additionally, according to embodiments of the present invention, theft of personal data may be fundamentally prevented by applying a function that manages and traces a history of user authentication results. Also, such a function may effectively deal with future disputes.

In addition, in the same manner as a conventional electronic financial transaction system using an accredited certificate, electronic user identification and encoding of data being transmitted and received are performed, thereby guaranteeing integrity. Furthermore, by providing an electronic signature (e-signature) verifying that the transaction history is not changed, the embodiments of the present invention may even be applied to an alienated class within a financial service, for example foreigners who are not allowed use of the accredited certification.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating relationships among a network control system, a user terminal, and a payment gateway (PG) system, according to an embodiment of the present invention;

FIG. 2 is a diagram illustrating an example comparing a conventional Internet payment service with an Internet payment service according to an embodiment of the present invention; and

FIG. 3 is a flowchart illustrating a network control method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. It is noted that to the present invention is not limited to the following embodiments.

A security control scheme according to an embodiment of the present invention is a client-and-server based network control scheme. The network control scheme consists of a client function equipped to a mobile terminal, that is a user terminal, including a plurality of network interfaces, and a server functioning as a network control system that manages the mobile terminal in real time based on a unique identifier (ID) assigned to the mobile terminal. The client function may be achieved by agent software of the user terminal. The server function may be achieved by the network control system that controls the user terminal based on the ID of the user terminal.

The client manages heterogeneous interfaces of the mobile terminal and makes and maintains a tunnel-based security relationship with the network control system. The client sets an active and standby interface according to a current link state, and continuously reflects the link state being varied according to movement of the mobile terminal. Here, a security tunnel is established between the client and the server in correspondence to each interface, such that communication between the client and the server is performed through the tunnel. According to changes of an access network to which the moving mobile terminal is connected, the client performs tunnel switching in a make before break (MBB) method. Since the security relationship between the client and the server is established based on the ID assigned to the mobile terminal, the security relationship may be maintained instead of the change of the access network. The unique ID of the mobile terminal may maintain compatibility with conventional technologies, using an IPv6 or IPv4 address.

The server is achieved by a reliable network control system guaranteeing integrity. The network control system manages network information varied according to a current state of the mobile terminal, based on the unique ID assigned to the mobile terminal. The network control system is always recognizes the current state of the mobile terminal, accordingly providing reliability among terminals and mediating secure data exchange. In addition, the network control system may store a transaction history as necessary in preparation for future disputes.

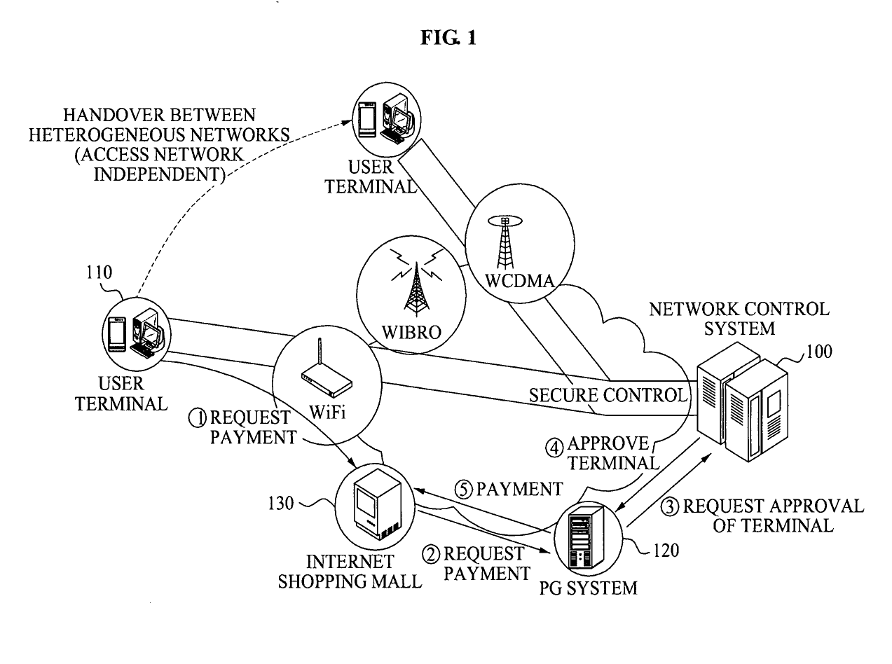

FIG. 1 is a diagram illustrating connection relations among a network control system 100, a user terminal 110, and a payment gateway (PG) system 120, according to an embodiment of the present invention.

Referring to FIG. 1, the user terminal 110 transmits terminal state information to the network control system 100, that is, a server.

The network control system 100 may manage the received terminal state information in real time, and perform user authentication using the terminal state information. For this purpose, the network control system 100 needs to be reliable to guarantee integrity. Due to such characteristics, the network control system 100 may be operated by an accredited certification organization or the like. For example, the network control system 100 may identify an access network and a secure channel to which the user terminal 110 connects, based on the received terminal state information.

By establishing a security relationship, the network control system 100 manages the user terminal 110 using network state information varied according to a current state of the user terminal 110 in addition to unique information of the user terminal 110. Accordingly, the network control system 100 can recognize the current state of the user terminal 110.

For example, the network control system 100 may recognize that a user terminal 1 of a user A was connected through a gateway installed at home of the user A at 7 o'clock and then changed to a network at a bus stop near the home at 8 o'clock.

The user terminal 110 maintaining the security relationship with the network control system 100 may report network-related information representing the current state to the network control system 100.

The user terminal 110 may include a plurality of network interfaces. Client software installed in the user terminal 110 manages the network interfaces of the user to terminal 110. When the user terminal 110 is turned on, the client continuously searches for a connection state of the user terminal 110 corresponding to the respective network interfaces, thereby setting an interface having a best connectivity as an active interface while setting an interface having a next best connectivity as as standby interface. A tunnel applying the security protocol between the client and the server is established through the active interface and the standby interface. Accordingly, a secure channel is established between the user terminal 110 and the server.

The client continuously performs switching between the active interface and the standby interface according to the connection state that is varied as the user terminal 110 moves. Here, an MBB-type interface switch method is used, in which the interface is switched to the standby interface while maintaining connectivity of the conventional active interface. Therefore, the secure channel may be continuously provided without interruption, even between heterogeneous networks. Thus, since the user terminal 110 uses a continuous service among various types of subscriber networks, although the access network to which the user terminal 110 is connected frequently changes, the network control system 100 may continuously maintain and manage the secure channel related to the user terminal 110, based on the unique ID of the user terminal 110 independent from types of the access network. Accordingly, connectivity of the user terminal 110 may be guaranteed by the network interface, so that the user terminal 110 is capable of making a secure payment at any time and at any location. In addition, since the network control system 100 recognizes the change of state of the user terminal 110 in real time, malicious use by copying and duplication of the user terminal 110 may be fundamentally prevented.

For this, the user terminal 110 may need a terminal agent, in other words, a terminal client to establish and maintain the security relationship with the network control system 100. That is, the user terminal 110 may transmit the terminal state information to the network control system 100 through the terminal agent.

The terminal agent may be the in the form of hardware like a user identifying device such as a universal subscriber identity module (USIM). However, for compatible use with a conventional terminal, the terminal agent may be software that is downloadable and installable by various methods including personal computer (PC) connection, short range radio technology, wireless Internet, and the like. That is, the terminal agent may be installed various types of hardware and operating systems (OS), independently from the OS of a corresponding terminal.

In addition, the terminal ID for identification of the user terminal 110 may be an Internet protocol (IP) address to minimize disagreement with the conventional scheme. Moreover, it is more exemplary to use the IPv6 address since it solves exhaustion of IP addresses of the conventional IPv4 and achieves various technical advances including mobility.

The PG system 120 uses conventional methods (□,□, and □) in relation to authentication and payment, and separately requests authentication of the user terminal 110 from the network control system 100 to increase reliability of the authentication and payment (□ and □). Here, the security relationship may also be established between the PG system 120 and the network control system 100. The PG system 120 may be a system equipped with an ‘agent’ functioning as a client in the same manner as the terminal agent. Also, the agent may be software that is downloadable and installable by various methods.

When the user terminal 110 purchases a product from an Internet shopping mall 130, the PG system 120 may be requested for payment by the Internet shopping mall 140 and request authentication of the user terminal 110 from the network control system 100.

When requested for authentication of the user terminal 110 by the PG system 120, the network control system 100 determines whether the user terminal 110 is authenticated based on the current state of the user terminal 110. The network control system 100 receives the terminal state information from the terminal agent equipped to the user terminal 110, and identifies the access network and the secure channel connected with the user terminal 110 based on the received terminal state information. In addition, the network control system 100 transmits the authentication result to the PG system 120. For example, the network control system 100 may control the PG system 120 to perform payment related to the user terminal 110 according to the authentication result.

When the user terminal 110 is authenticated according to the received authentication result, the PG system 120 may perform Internet payment requested by the user terminal 110. When the user terminal 110 is not authenticated, the PG system 120 may not perform the Internet payment requested by the user terminal 110.

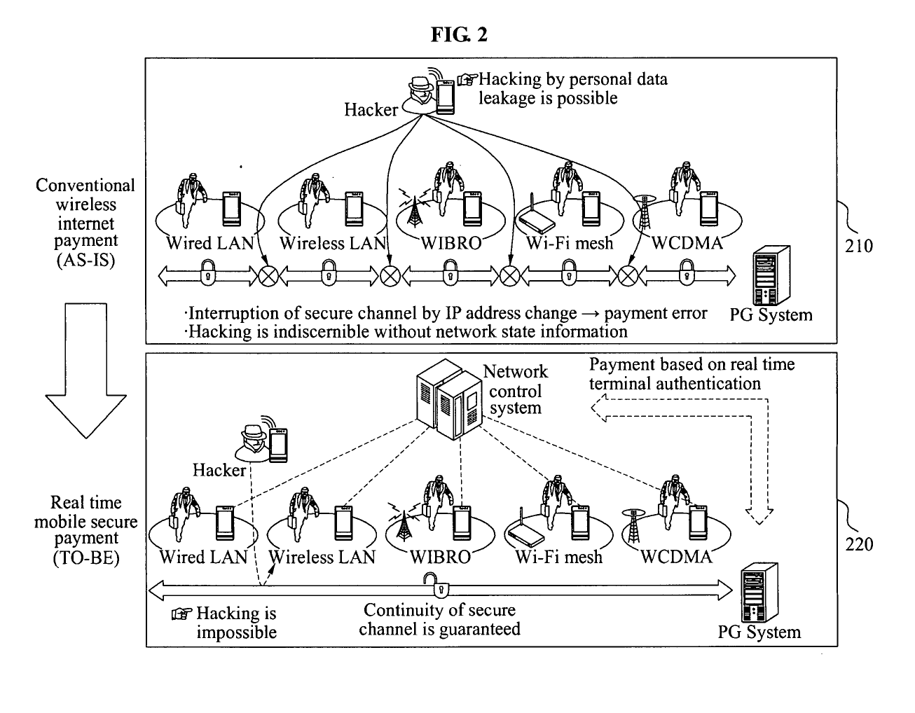

FIG. 2 illustrates an example comparing a conventional Internet payment service 210 with an Internet payment service according to an embodiment of the present invention.

Referring to FIG. 2, in the conventional Internet payment service 210, when the user terminal 110 requests the PG system 120 for payment through a wireless Internet connection, the secure channel is interrupted since addresses between heterogeneous networks are not compatible. Accordingly, an error occurs regarding the payment. Additionally, the conventional Internet payment service 210 is not capable of recognizing hacking without the network state information, that is, control information on the user terminal 110.

However, the Internet payment service 220 according to an embodiment controls the payment operation between the user terminal 110 and the PG system 120 based on the network state information of the user terminal 110, thereby securing continuity of the secure channel between heterogeneous networks. Therefore, hacking is prevented.

That is, the embodiment of the present invention provides a secure payment service by guaranteeing continuity of the secure channel even on the Internet where handover between heterogeneous networks is frequent.

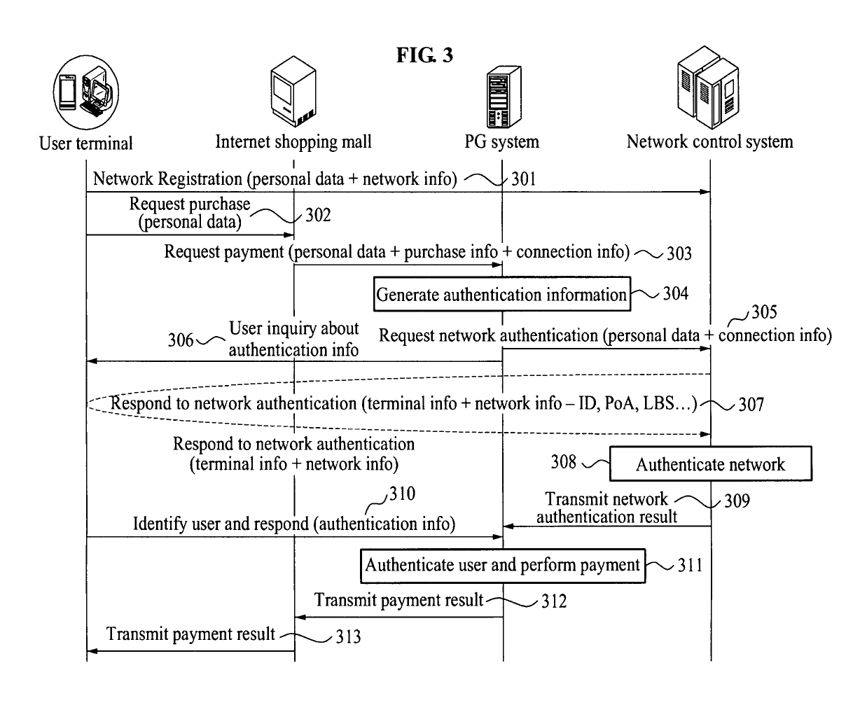

FIG. 3 is a flowchart illustrating a network control method according to an embodiment of the present invention.

Referring to FIG. 3, in operation 301, when the user terminal 110 is initially powered on, the user terminal 110 performs network registration with respect to the network control system 100. Here, the user terminal 110 may transmit personal data based on subscriber information, and network information to the network control system 100.

For example, the personal data refers to basic information for identification of a corresponding subscriber. The personal data may include basic identification information for identifying a user, such as a social security number, and additional information for use of the network service. Here, a global ID such as a passport number may be used as a user ID suitable for global electronic trading.

The network information, that is the network state information, may include basic terminal identifying methods, such as a terminal ID and a unique terminal address for identification of the user terminal 110, and information related to the network state, such as an access network type, an access place, and an access time of the user terminal 110 currently in use. Here, the terminal ID needs to be independent from the type of an access scheme. That is, the terminal ID needs to be able to identify the user terminal 110 regardless of a type of the access network currently connected. Therefore, since the user terminal 110 cannot be identified by only a network interface address, the terminal ID is indispensable. Here, the Internet address may be used as the terminal ID for compatible use of the conventional IP scheme.

Next, the user terminal 110 may periodically report the terminal state information to the network control system 100, and transmit the network state information that is varied according to the environment to the network control system 100. Accordingly, the network control system 100 manages the state of the user terminal 110, for example, according to when, where, and how the user terminal 110 is connected to the network. Here, the network control system 100 may also manage a network access history of the user terminal 110. Therefore, tracing of the user terminal 110 may be performed as necessary.

Since the aforementioned functions of the user terminal 110 are to be built in the user terminal 110 as software or hardware, those functions may be provided as additional services when the user subscribes for the user terminal 110 to use the network service. For users who apply for the additional services later, not at the time of the subscription, a patch solution related to the existing user terminal 110 may be provided to enable the users to easily start the additional services.

In addition, in case of loss of the user terminal 110, the user may report the loss to a corresponding network service provider. In this case, the network service provider may suspend the service of the lost user terminal 110, or trace the state of the lost user terminal 110 and inform the user of the current state of the lost user terminal 110.

Next, in operation 302, when using the Internet service including financial transactions, stock trading, Internet shopping, and the like, the user terminal 110 may request a purchase of an Internet service product to a corresponding service provider such as the Internet shopping mall 130. Here, the user terminal 110 transmits personal data of the user to the Internet shopping mall 130 so that the Internet shopping mall 130 identifies the user. For example, transmission of the personal data may be achieved by the user logging-in. When the user logs in the Internet shopping mall 130 through the user terminal 110, the Internet shopping mall 130 already having the subscriber information, may acquire the personal data.

In operation 303, the Internet shopping mall 130 requested for the purchase requests the PG system 120 to perform payment. Although the Internet shopping mall 130 may be equipped with a payment system and directly perform the payment, according to the current general electronic commerce system, a dedicated electronic payment gateway performs the payment.

The Internet shopping mall 130 transmits information necessary for the payment to the PG system 120. In general, the information may include the personal data based on the subscriber information, and purchase information related to the service to be used. Based on the personal data and the purchase information, the Internet shopping mall 130 recognizes a purchaser, a purchased service, and a price. Furthermore, when the Internet shopping mall 130 is capable of checking information on the network to which the user is connected, the Internet shopping mall 130 may also transmit connection information to the PG system 120 for use in authentication of the network. Here, when the connection information of the user terminal 110 is not transmitted to the PG system 120, the network control system 10 may check the network state information of the user terminal 110 through a separate process (operation 307).

Next, according to cases, the PG system 120 may perform the payment based on the personal data and the purchase information, and transmit a payment result to a payment requesting system such as the Internet shopping mall 130, in operations 310, 311, and 312.

Alternatively, for more secure payment as in operation 304, the PG system 120 may generate authentication information for confirming the personal data and the purchase data. The confirmation may be performed in various methods, by a unique process according to a type of the PG system 120.

In operation 306, the PG system 120 transmits the authentication information generated for user identification, to the user terminal 110. The user identification method may be varied according to the unique process of the PG system 120. Generally, a separate bypass network such as a short message service (SMS) is used to securely identify the user. Next, when the PG system 120 receives a normal response in operation 309, the PG system 120 performs the payment and transmits the payment result in operations 310, 311, 312.

It is exemplary to manage a history of the above processes in preparation for future disputes.

The above-mentioned processes are identical or similar to conventional payment processes, and may be applied in various manners according to the conventional processes.

However, for the network-based secure payment according to the embodiment of the present invention, after the PG system 120 receives the request for payment in operation 303, the PG system 120 may request the network control system 100 for network authentication based on the personal data related to the user terminal 110, in operation 305. Operation 305 is performed to confirm whether the user terminal 110 requesting the payment to the PG system 120 is a normal terminal. Specifically, the PG system 120 makes a network authentication inquiry about ‘By who (personal data) and where (network information) the payment is requested?’ to the network control system 100. For this, the PG system 120 may transmit the personal data and the connection information related to the user terminal 110 to the network control system 100. Here, when the information transmitted from the PG system 120 to the network control system 100 is sufficient to respond to the network authentication inquiry, the network control system 100 already having the terminal state information may promptly perform the “network authentication.”

When not receiving the network information of the user terminal 110 from the PG system 120 for various reasons, the network control system 100 may perform the network authentication through the dedicated process of operation 307.

In operations 307 and 308, the network control system 100 requested for the network authentication performs the network authentication to check whether the user terminal 110 is currently using the service. First, the network control system 100 stores the network authentication as a history to prevent future disputes. Next, the network control system 100 requests the network authentication to the user terminal 110 based on the received personal data.

When the network control system 100 is capable of receiving information related to the user terminal 110 and the network from the PG system, the network control system 100 may periodically receive the terminal state information from the user terminal 110 and perform the network authentication according to whether the two sets of information correspond.

When the network control system 100 is incapable of receiving the information related to the network, the network authentication may be performed in various practical manners.

The network control system 100 may inquire the user terminal 110 about an Internet service the user terminal 110 is currently using. In response to the inquiry, the user terminal 110 may transmit a network authentication response to the network control system 100. The response may contain information on the unique number of the user terminal 110, such as a lifetime address, a current access place, a current network type, a currently used service, and the like.

The authentication process may include confirmation by the user. However, it is exemplary that the user terminal 110 automatically respond without the user confirmation, in order to avoid a redundant confirmation process required when the PG system 120 inquires the user, prevent counterfeit of information in preparation for theft of the user terminal 110, and reduce the whole process time by reducing time for the network authentication.

In operation 309, when the network authentication is completed, the network control system 100 may transmit the authentication result to the PG system 120 that requested the network authentication. Here, the network control system 100 may store the network authentication history in preparation for future disputes and tracing of malicious use cases.

In operation 310, in response to a request for confirmation of the authentication information inquired from the PG system 120, the user terminal 110 may transmit a result of confirming the authentication information to the PG system 120. This process may be performed in the same manner as the conventional method.

Next, in operation 311, the PG system 120 may combine the network-based authentication result and the authentication result by a user inquiry about the authentication information, thereby completing the user authentication.

In operations 312 and 313, the PG system 120 may transmit the payment result after the authentication is completed, to the Internet shopping mall 130 and the user terminal 110.

Although the embodiments of the present invention have been explained mainly about the secure payment and user authentication for use of the financial service, the same scheme may be applied to any field requiring user authentication and security, such as mobile electronic payment, mobile groupware, mobile electronic government, and the like.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A network control method for controlling a client/server based high-reliability session for secure payment, considering both network layer and application layer information concurrently, using a multiple network interface user terminal in the heterogeneous network environment, the method comprising:
transmitting terminal state information to a network control system through a terminal agent provided to a user terminal;
identifying a homogeneous or heterogeneous access network and a secure channel to which the user terminal connects, by the network control system, based on the terminal state information transmitted;
requesting the network control system for authentication of the user terminal through a server agent equipped to a payment gateway (PG) system when the user terminal requests payment to the PG system;
determining whether the user terminal is authenticated based on the access network and the secure channel corresponding to the authentication requested by the network control system, and transmitting the determination result to the PG system; and
performing payment related to the user terminal by the PG system according to the transmitted determination result.
